(19) United States
(12) Patent Application Publication
(10) Pub. No.: US 2014/0253019 A1
(43) Pub. Date: Sep. 11, 2014

(54) Charger Circuit and Control Circuit and Control Method Thereof

(71) Applicant: Chih-Hsien Wang, Pingzhen City (TW)

(72) Inventor: Chih-Hsien Wang, Pingzhen City (TW)

(73) Assignee: RICHTEK TECHNOLOGY CORPORATION, Chupei City (TW)

(21) Appl. No.: 13/786,702

(22) Filed: Mar. 6, 2013

(51) Int. Cl. H02J 7/00

(52) U.S. Cl. CPC H02J 7/0052
USPC 320/107; 320/162

(57) ABSTRACT

The present invention discloses a charger circuit and a control circuit and a control method thereof. The charger circuit supplies a charging current to charge a battery. The charger circuit includes a bipolar junction transistor (BJT) pass circuit, a current sensing circuit, a voltage sensing circuit and a control circuit. The BJT pass circuit is coupled to an input voltage and generates the charging current in response to a control signal. The control circuit includes a current adjustment circuit, which adjusts a first resistance of a first variable resistor device included therein according to the current sensing signal and a current reference signal so as to adjust the control signal; and a voltage adjustment circuit, which adjusts a second resistance of a second variable resistor device included therein according to the voltage sensing signal and a voltage reference signal so as to adjust the control signal.

### BACKGROUND OF THE INVENTION

1. Field of Invention

The present invention relates to a charger circuit and a control circuit and a control method thereof; particularly, it relates to a charger circuit including a bipolar junction transistor (BJT) pass device and a control circuit and a control method of such a charger circuit.

2. Description of Related Art

FIG. 1 shows a schematic circuit diagram of a conventional charger circuit 1 including a P-type metal oxide semiconductor (PMOS) pass device. As shown in FIG. 1, the charger circuit 1 is electrically connected to a battery circuit 11 and supplies charging current I1 to charge a battery in the battery circuit 11. The charger circuit 1 comprises a PMOS pass circuit 12 and a control circuit 13, which form a low-dropout regulator (LDO). The PMOS pass circuit 12 includes a PMOS pass device Q1 and a diode device D1. The diode device D1 is for preventing a reverse current from flowing from the battery circuit 11 to an input terminal Vin under the circumstance where an external power source (not shown) does not supply power to the input terminal Vin. Please refer to FIG. 2, which shows a schematic circuit diagram of another conventional charger circuit 2. The charger circuit 2 comprises a pass circuit 22 and a control circuit 23. The charger circuit 2 is different from the charger circuit 1 in that the pass circuit 22 includes a bipolar junction transistor (BJT) pass device Q2 rather than a PMOS pass device Q1. The BJT device does not have a problem of reverse current caused by a parasitic diode as in the PMOS device. Hence, not only the reversed current flowing form the battery circuit 11 to an input terminal Vin is avoided, but also the cost and the space for a diode device are saved.

Nevertheless, the BJT pass device Q2 is controlled by a base current; in comparison with the PMOS device Q1 which is controlled by a gate voltage, the control circuit 23 for the BJT pass device Q2 is much more complicated. Another drawback is that, for a charger circuit 2 including a BJT pass device Q2, it is difficult to construct an LDO circuit, so it is difficult to control both the charging current and the battery voltage of the battery circuit 11. Conventional solutions to this is to employ a complicated control mechanism and hardware circuit, or a complicated software program, to control the BJT pass device Q2 and generate a pulsation charging current, causing the design of the control circuit to be even more complicated, which increases the manufacturing cost and reduces the efficiency.

In view of the above, to overcome the drawbacks in the prior art, the present invention proposes a charger circuit and a control circuit and a control method of a charger circuit, wherein the charger circuit includes a BJT pass device but does not require a complicated hardware circuit and complicated software control.

### SUMMARY OF THE INVENTION

A first objective of the present invention is to provide a charger circuit.

A second objective of the present invention is to provide a control circuit of a charger circuit.

A third objective of the present invention is to provide a control method of a charger circuit.

To achieve the above and other objectives, from one perspective, the present invention provides a charger circuit for supplying a charging current to charge a battery in a battery circuit, the charger circuit comprising: a bipolar junction transistor (BJT) pass circuit coupled to an input voltage, for generating the charging current in response to a control signal; a current sensing circuit for generating a current sensing signal related to the charging current; a voltage sensing circuit coupled to the battery circuit, for generating a voltage sensing signal related to a battery voltage of the battery; and a control circuit coupled to the BJT pass circuit, for generating the control signal according to the current sensing signal and the voltage sensing signal, the control circuit including: a current adjustment circuit coupled to the current sensing circuit, for adjusting a first resistance of a first variable resistor device included in the current adjustment circuit according to the current sensing signal and a current reference signal, to thereby adjust the control signal; and a voltage adjustment circuit coupled to the voltage sensing circuit, for adjusting a second resistance of a second variable resistor device included in the voltage adjustment circuit according to the voltage sensing signal and a voltage reference signal, to thereby adjust the control signal.

From another perspective, the present invention provides a control circuit of a charger circuit, for generating a control signal according to a current sensing signal and a voltage sensing signal so as to control a BJT pass circuit to regulate a charging current for charging a battery in a battery circuit, wherein the current sensing signal is related to the charging current and the voltage sensing signal is related to a battery voltage of the battery; the control circuit comprising: a current adjustment circuit coupled to the BJT pass circuit, for adjusting a first resistance of a first variable resistor device included in the current adjustment circuit according to the current sensing signal and a current reference signal to thereby adjust the control signal; and a voltage adjustment circuit coupled to the battery circuit, for adjusting a second resistance of a second variable resistor device included in the voltage adjustment circuit according to the voltage sensing signal and a voltage reference signal to thereby adjust the control signal.

From yet another perspective, the present invention provides a control method of a charger circuit, comprising the steps of: providing a BJT pass circuit for generating a charging current in response to a control signal, to charge a battery; generating a current sensing signal related to the charging current; generating a voltage sensing signal related to a battery voltage of the battery; and generating the control signal according to the current sensing signal and the voltage sensing signal; wherein the step of generating the control signal includes: adjusting a first resistance of a first variable resistor device according to the current sensing signal and a current reference signal, to thereby adjust the control signal; and adjusting a second resistance of a second variable resistor device according to the voltage sensing signal and a voltage reference signal, to thereby adjust the control signal.

In one embodiment, the control circuit further includes: a protection circuit coupled to the BJT pass circuit, for determining a highest voltage received by the BJT pass circuit and/or the control circuit.

In one embodiment, the control circuit further includes: a start-up circuit for generating the control signal when the battery voltage is lower than a predetermined low voltage.

In one embodiment, the current adjustment circuit further includes: a current sensing and amplification circuit coupled to the current sensing circuit, for generating a current sensing and amplification signal according to the current sensing signal; and a current error amplifier circuit coupled to the current sensing and amplification circuit, for comparing the current sensing and amplification signal with the current reference signal to generate a first resistor adjustment signal; wherein the first variable resistor device is coupled to the current error amplifier circuit and is for adjusting the first resistance in response to the first resistor adjustment signal.

In one embodiment, the voltage adjustment circuit includes: a voltage error amplifier circuit coupled to the voltage sensing circuit, for comparing the voltage sensing signal with the voltage reference signal to generate a second resistor adjustment signal; wherein the second variable resistor device is coupled to the voltage error amplifier circuit and is for adjusting the second resistance in response to the second resistor adjustment signal.

In one embodiment, the BJT pass circuit includes: a BJT pass device coupled between the input voltage and the battery circuit, for controlling the charging current according to the control signal; and a voltage limitation circuit coupled to the control circuit, for limiting a voltage of a connection node connected between the control signal and the BJT pass circuit to be not higher than a predetermined level.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic circuit diagram of a conventional charger circuit 1.

FIG. 2 shows a schematic circuit diagram of a conventional charger circuit 2.

FIG. 3 shows a schematic diagram of a charger circuit according to an embodiment of the present invention.

FIG. 3A shows a more specific embodiment of the present invention.

FIG. 4 shows a schematic diagram of a charger circuit according to another embodiment of the present invention.

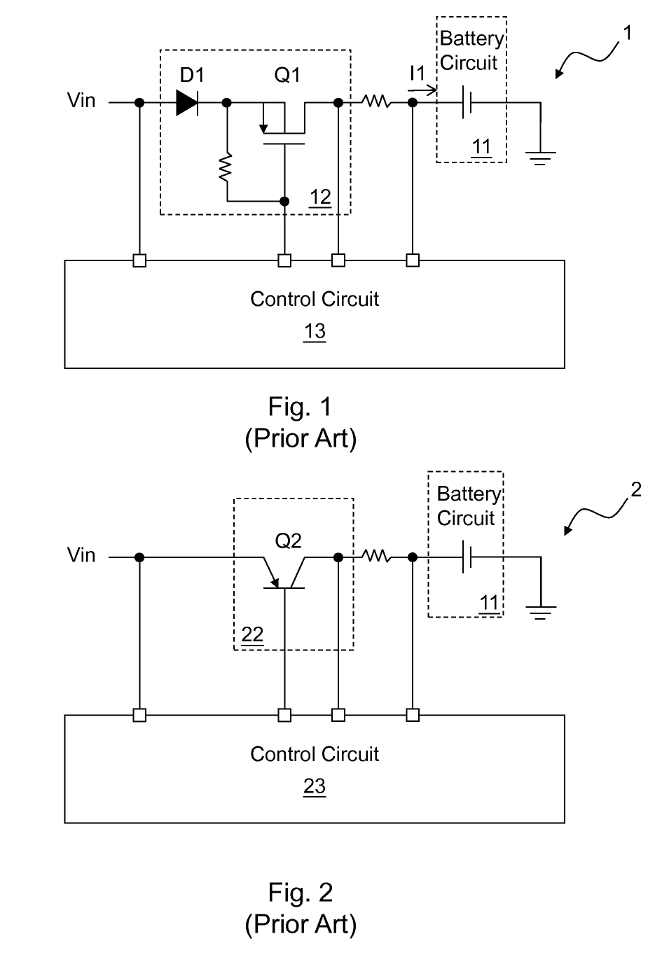

### DESCRIPTION OF THE PREFERRED EMBODIMENTS

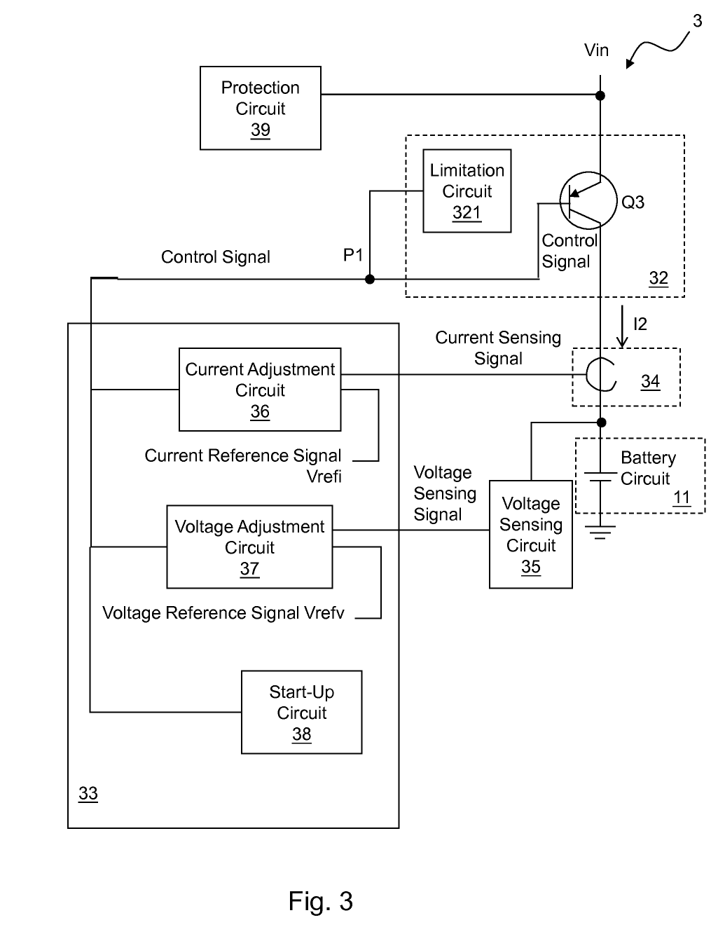

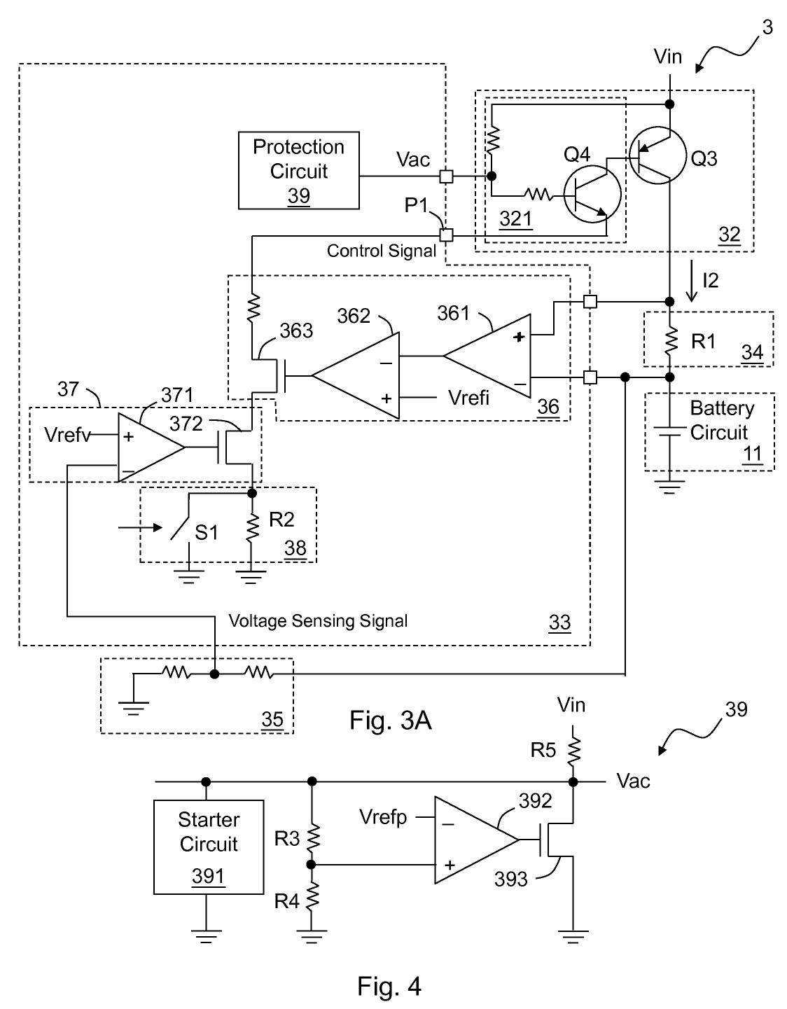

Please refer to FIG. 3, which shows a schematic diagram of a charger circuit 3 according to an embodiment of the present invention. As shown in FIG. 3, the charger circuit 3 is electrically connected to a battery circuit 11 and supplies a charging current I2 to charge a battery in the battery circuit 11. The charger circuit 3 comprises a BJT pass circuit 32, a control circuit 33, a current sensing circuit 34 and a voltage sensing circuit 35. The BJT pass circuit 32 is coupled to an input voltage Vin, and is controlled by a control signal to generate the charging current I2. The BJT pass circuit 32 includes, for example but not limited to, a BJT pass device Q3, and, optionally (but not necessarily), a voltage limitation circuit 321. The BJT pass device Q3 is coupled between the input voltage Vin and the battery circuit 11 and controls the charging current I2 according to the control signal. The voltage limitation circuit 321 is coupled to the control circuit 33 and its function is to limit the voltage at a connection node (P1) between the control signal and the BJT pass circuit 32 to be not higher than a predetermined level. The predetermined level is, for example but not limited to, 5V or 3V. As such, the devices in the control circuit 33 can be protected and not to receive a high voltage. The current sensing circuit 34 generates a current sensing signal according to the charging current I2. The voltage sensing circuit 35 is coupled to the battery circuit 11 and generates a voltage sensing signal related to the battery voltage. The control circuit 33 generates the control signal according to the current sensing signal and the voltage sensing signal, to control the BJT pass circuit 32. The control circuit 33 includes a current adjustment circuit 36, a voltage adjustment circuit 37, and, optionally (but not necessarily), a start-up circuit 38. The current adjustment circuit 36 is coupled to the current sensing circuit 34 and adjusts the control signal according to the current sensing signal and a current reference signal Vrefi. The voltage adjustment circuit 37 is coupled to the voltage sensing circuit 35 and adjusts the control signal according to the voltage sensing signal and a voltage reference signal Vrefv. The function of the start-up circuit 38 is to generate a start-up current at a start-up stage.

Please refer to FIG. 3A, which shows a more specific embodiment of the present invention. As shown in FIG. 3A, the voltage limitation circuit can be, for example but not limited to, a BJT device Q4; it can be any other device such as one or more MOS devices and/or one or more diode devices, which is capable of limiting the voltage at the connection node P1. The current sensing circuit 34, for example, takes a voltage difference between two ends of a resistor R1 through which the charging current I2 flows as the current sensing signal, and the current sensing signal is inputted to the control circuit 33. The voltage sensing circuit 35, for example, takes a divided voltage from one of two resistors connected in series to the battery in the battery circuit 11 as the voltage sensing signal, and the voltage sensing signal is inputted to the control circuit 33. The control circuit 33 receives the current sensing signal and the voltage sensing signal and generates the control signal to control the BJT pass circuit 32, thereby adjusting the charging current I2 and the battery voltage. However, it should be noted that the above-mentioned current sensing method and voltage sensing method are only illustrative examples, but not for limiting the scope of the present invention. Any current sensing method or voltage sensing method can be used in the present invention.

The control circuit 33 comprises two control loops, namely the current adjustment circuit 36 and the voltage adjustment circuit 37. The current adjustment circuit 36 includes, for example but not limited to, a current sensing and amplification circuit 361, a current error amplifier circuit 362 and a variable resistor device 363. The current sensing and amplification circuit 361 can be, for example but not limited to, an amplifier circuit as shown in FIG. 3A. The current sensing and amplification circuit 361 is coupled to the current sensing circuit 34 and generates a current sensing and amplification signal according to the current sensing signal. The current sensing and amplification signal is inputted to the current error amplifier circuit 362 and compared with the current reference signal Vrefi. The comparison result is used to adjust a resistance of the variable resistor device 363, thus adjusting the control signal. The variable resistor device 363 can be, for example but not limited to, a MOS device as shown in FIG. 3A. A MOS device can become a variable resistor because its conductive resistance, when being operated in a linear region, is dependent on the gate voltage. However, the variable resistor device 363 is not limited to the embodiment shown in the figure. Any type of variable resistor device 363 can be used as long as the variable resistor device 363 is controllable by the output signal from the current error amplifier circuit 362. The control loop formed by the current adjustment circuit 36 provides the function to control the charging current I2, so that in a current control mode of the battery circuit 11, the charging current I2 is controlled at a value corresponding to the current reference signal Vrefi.

The voltage adjustment circuit 37 includes, for example but not limited to, a voltage error amplifier circuit 371 and a variable resistor device 372. The voltage error amplifier circuit 371 can be, for example but not limited to, an amplifier circuit as shown in FIG. 3A. The voltage error amplifier circuit 371 is coupled to the voltage sensing circuit 35 and receives a voltage sensing signal. The voltage sensing signal inputted to the voltage error amplifier circuit 371 is compared with the voltage reference signal Vrefv. The comparison result is used to adjust a resistance of the variable resistor device 372, thus adjusting the control signal. The variable resistor device 372 can be, for example but not limited to, a MOS device as shown in FIG. 3A. Such MOS device can become an variable resistor because its conductive resistor, when being operated, is linearly dependent on the gate voltage. Certainly, the variable resistor device 372 is limited to the figure shown. Any type of variable resistor device 372 can be used as long as the variable resistor device 372 is controllable by the output signal from the current error amplifier circuit 371. The control loop formed by the voltage adjustment circuit 37 provides the function to control the BJT pass circuit 32, so that in a voltage control mode of the battery circuit 11, the battery voltage is controlled at a predetermined level.

In this embodiment, the variable resistor devices 363 and 372 are coupled to each other, for example but not limited to the series connection as shown in FIG. 3A, so as to adjust the control signal together. The current adjustment circuit 36 and the voltage adjustment circuit 37 are capable of adjusting themselves adaptively, so that the charger circuit 3 can properly operate under the current control mode or the voltage control mode. The above-mentioned feature is an important feature of the present invention which is superior to the prior art. With a simple circuit structure, the charger circuit 3 can adaptively switch between the current control mode and the voltage control mode when the battery voltage is at different levels, thus achieving optimal charging control without requiring a complicated hardware circuit or software program.

More specifically, when the battery voltage is at a lower level, it is required to charge the battery circuit 11 with a constant current, which is the so-called constant current (CC) mode; when the battery voltage is at a higher level (near saturation voltage of the battery), it is required to regulate the battery voltage when charging the battery, and the current is variable in this case, which is the so-called constant voltage (CV) mode. In the present invention, the current adjustment circuit 36 and the voltage adjustment circuit 37 are capable of adjusting themselves adaptively to switch between the above-mentioned CC and CV modes.

Referring to FIG. 3A, when the battery voltage is at a lower level, the difference between the two input terminals of the voltage error amplifier circuit 371 is very large because the voltage sensing signal is at a low level. Therefore, the resistance of the variable resistor device 372 is very low and is almost fully turned ON, so the control signal is determined by the variable resistor device 363. Thus, the current control loop dominates the control; that is, the current adjustment circuit 36 dominates to control the charging current I2, so the charger circuit 3 operates in the CC mode. When the battery voltage reaches a higher level (near the saturation voltage of the battery), the voltage difference between two ends of the resistor R1 is reduced, so the difference between the two input terminals of the current error amplifier circuit 362 is very large. Therefore, the resistance of the variable resistor device 363 is very low and is almost fully turned ON, so the control signal is controlled by the variable resistor device 372. Thus, the voltage control loop dominates the control; that is, the voltage adjustment circuit 37 dominates to control the battery voltage in response to the voltage sensing signal and the voltage reference signal Vrefv, so the charger circuit 3 operates in the CV mode. The switching between the charging control modes is achieved adaptively by the circuit itself, without a complicated hardware circuit or software program.

In addition, in one embodiment, the control circuit 33 further includes, for example but not limited to, a start-up circuit 38, which also controls the control signal. The start-up circuit 38 includes, for example but not limited to, a switch S1 and a resistor R2 which are connected to each other in parallel. The switch S1 is turned ON under normal operation. The function of the start-up circuit 38 is to generate a proper control signal when the battery voltage is lower than a predetermined low voltage, so as to prevent the control circuit 33 from being unable to start operation when the battery voltage is at an extremely low level. In detail, when the battery voltage is lower than a predetermined low voltage, the control circuit 33 generates a low voltage signal to turn OFF the switch S1, so that the control signal can be generated by the current flowing though the resistor R2, and the charger circuit 3 starts operation in the current control mode. After entering the current control mode, the control circuit 33 turns ON the switch S1, whereby the current adjustment circuit 36 and the voltage adjustment circuit 37 start controlling the charging together.

Please still refer to FIG. 3A. The control circuit 33 further includes, for example but not limited to, a protection circuit 39. The protection circuit 39 is coupled to the input voltage Vin and the BJT pass circuit 32, to limit a highest voltage received by the BJT pass circuit 32 and/or the control circuit 33, so as to protect the devices of the BJT pass circuit 32 and the control circuit 33.

FIG. 4 shows a more specific embodiment of a protection circuit 39. As shown in FIG. 4, the protection circuit 39 can be, for example but not limited to, a shunt low-dropout regulator (LDO) circuit. The protection circuit 39 includes, for example, a starter circuit 391, an error amplifier circuit 392 and resistors R3, R4 and R5. In FIG. 4, the voltage Vac can be represented by the following equation:

Vac=Vrefp(R3+R4)/R4

Hence, the voltage Vac is determined by the protection reference signal Vrefp and the resistors R3 and R4. The current flowing through the resistor R5 can be represented by the following equation, wherein I(R5) is the current flowing through the resistor R5:

I(R5)=(Vin−Vac)/R5

The resistor R5 is preferably a resistor capable of withstanding higher power, and preferably has a resistance so that the current flowing through the resistor R5 is not too large when the input voltage Vin is, for example, 30V or above. The starter circuit 391 is for starting up the circuit, which is well known to those skilled in the art, so its details are omitted here. The Shunt LDO circuit formed by the error amplifier circuit 392 and the switch 393 in the protection circuit 39 can regulate the voltage Vac at a predetermined voltage which is not higher than a protection limit, to protect the low voltage devices in the control circuit 33.

Another feature of the present invention which is superior to the prior art is that: when the battery is taken out, the charger circuit of the present invention can still function through the LDO circuit, to provide a stable regulated voltage. In the prior art which supplies pulsation current, when the battery is taken out, the circuit can no longer provide any function. Moreover, the present invention has another advantage, which is: because the present invention controls the base current of the BJT device instead of the gate voltage of a PMOS device, the design for the compensation circuit is easier in the present invention than the design of the compensation circuit in the case of controlling the gate voltage. The present invention can tolerate very large output loading range, and it can operate stably when it operates as an LDO circuit.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, a device which does not substantially influence the primary function of a signal can be inserted between any two devices in the shown embodiments, such as a switch. For another example, the positive and negative input terminals of an error amplifier circuit or a comparator are interchangeable, with corresponding amendments of the circuits processing these signals. In view of the foregoing, the spirit of the present invention should cover all such and other modifications and variations, which should be interpreted to fall within the scope of the following claims and their equivalents.

What is claimed is:

1. A charger circuit for supplying a charging current to charge a battery in a battery circuit, the charger circuit comprising:
a bipolar junction transistor (BJT) pass circuit coupled to an input voltage, for generating the charging current in response to a control signal;
a current sensing circuit for generating a current sensing signal related to the charging current;
a voltage sensing circuit coupled to the battery circuit, for generating a voltage sensing signal related to a battery voltage of the battery; and
a control circuit coupled to the BJT pass circuit, for generating the control signal according to the current sensing signal and the voltage sensing signal, the control circuit including:
a current adjustment circuit coupled to the current sensing circuit, for adjusting a first resistance of a first variable resistor device included in the current adjustment circuit according to the current sensing signal and a current reference signal, to thereby adjust the control signal; and
a voltage adjustment circuit coupled to the voltage sensing circuit, for adjusting a second resistance of a second variable resistor device included in the voltage adjustment circuit according to the voltage sensing signal and a voltage reference signal, to thereby adjust the control signal.

2. The charger circuit of claim 1, wherein the control circuit further includes:
a protection circuit coupled to the BJT pass circuit, for determining a highest voltage received by the BJT pass circuit and/or the control circuit.

3. The charger circuit of claim 1, wherein the control circuit further includes:
a start-up circuit for generating the control signal when the battery voltage is lower than a predetermined low voltage.

4. The charger circuit of claim 1, wherein the current adjustment circuit further includes:
a current sensing and amplification circuit coupled to the current sensing circuit, for generating a current sensing and amplification signal according to the current sensing signal; and
a current error amplifier circuit coupled to the current sensing and amplification circuit, for comparing the current sensing and amplification signal with the current reference signal to generate a first resistor adjustment signal;
wherein the first variable resistor device is coupled to the current error amplifier circuit and is for adjusting the first resistance in response to the first resistor adjustment signal.

5. The charger circuit of claim 1, wherein the voltage adjustment circuit includes:
a voltage error amplifier circuit coupled to the voltage sensing circuit, for comparing the voltage sensing signal with the voltage reference signal to generate a second resistor adjustment signal;
wherein the second variable resistor device is coupled to the voltage error amplifier circuit and is for adjusting the second resistance in response to the second resistor adjustment signal.

6. The charger circuit of claim 1, wherein the BJT pass circuit includes:
a BJT pass device coupled between the input voltage and the battery circuit, for controlling the charging current according to the control signal; and
a voltage limitation circuit coupled to the control circuit, for limiting a voltage of a connection node connected between the control signal and the BJT pass circuit to be not higher than a predetermined level.

7. The charger circuit of claim 1, wherein the first variable resistor device and the second variable resistor device are connected to each other in series.

8. A control circuit of a charger circuit, for generating a control signal according to a current sensing signal and a voltage sensing signal so as to control a BJT pass circuit to regulate a charging current for charging a battery in a battery circuit, wherein the current sensing signal is related to the charging current and the voltage sensing signal is related to a battery voltage of the battery; the control circuit comprising:
a current adjustment circuit coupled to the BJT pass circuit, for adjusting a first resistance of a first variable resistor device included in the current adjustment circuit according to the current sensing signal and a current reference signal to thereby adjust the control signal; and
a voltage adjustment circuit coupled to the battery circuit, for adjusting a second resistance of a second variable resistor device included in the voltage adjustment circuit according to the voltage sensing signal and a voltage reference signal to thereby adjust the control signal.

9. The control circuit of claim 8, further comprising:
a protection circuit coupled to the BJT pass circuit, for determining a highest voltage received by the BJT pass circuit and/or the control circuit.

10. The control circuit of claim 8, further comprising:
a start-up circuit for generating the control signal when the battery voltage is lower than a predetermined low voltage.

11. The control circuit of claim 8, wherein the current adjustment circuit includes:
a current sensing and amplification circuit coupled to the current sensing circuit, for generating a current sensing and amplification signal according to the current sensing signal; and
a current error amplifier circuit coupled to the current sensing and amplification circuit, for comparing the current sensing and amplification signal with the current reference signal to generate a first resistor adjustment signal;
wherein the first variable resistor device is coupled to the current error amplifier circuit and is for adjusting the first resistance in response to the first resistor adjustment signal.

12. The control circuit of claim 8, wherein the voltage adjustment circuit includes:
a voltage error amplifier circuit coupled to the voltage sensing circuit, for comparing the voltage sensing signal with the voltage reference signal to generate a second resistor adjustment signal;
wherein the second variable resistor device is coupled to the voltage error amplifier circuit and is for adjusting the second resistance in response to the second resistor adjustment signal.

13. The control circuit of claim 8, wherein the BJT pass circuit includes:
a BJT pass device coupled between the input voltage and the battery circuit, for controlling the charging current according to the control signal; and
a voltage limitation circuit coupled to the control circuit, for limiting a voltage of a connection node connected between the control signal and the BJT pass circuit to be not higher than a predetermined level.

14. The control circuit of claim 8, wherein the first variable resistor device and the second variable resistor device are connected to each other in series.

15. A control method of a charger circuit, comprising the steps of:
providing a BJT pass circuit for generating a charging current in response to a control signal, to charge a battery;
generating a current sensing signal related to the charging current;
generating a voltage sensing signal related to a battery voltage of the battery; and
generating the control signal according to the current sensing signal and the voltage sensing signal;
wherein the step of generating the control signal includes:
adjusting a first resistance of a first variable resistor device according to the current sensing signal and a current reference signal, to thereby adjust the control signal; and
adjusting a second resistance of a second variable resistor device according to the voltage sensing signal and a voltage reference signal, to thereby adjust the control signal.

16. The control method of claim 14, further comprising:
providing a start-up current as the control signal when the battery voltage is lower than a predetermined low voltage.

17. The control method of claim 14, wherein the step of adjusting the first resistance of the first variable resistor device includes:
generating a current sensing and amplification signal according to the current sensing signal;
comparing the current sensing and amplification signal with the current reference signal so as to generate a first resistor adjustment signal; and
adjusting the first resistance in response to the first resistor adjustment signal.

18. The control method of claim 14, wherein the step of adjusting the second resistance of the second variable resistor device includes:
comparing the voltage sensing signal with the voltage reference signal so as to generate a second resistor adjustment signal; and
adjusting the second resistance in response to the second resistor adjustment signal.
